(19) United States
(12) Patent Application Publication
(10) Pub. No.: US 2005/0053396 A1
(43) Pub. Date: Mar. 10, 2005

(54) Image forming apparatus and charging device

(75) Inventors: Tatsuya Kubo, Ibaraki (JP); Hiroyuki Mabuchi, Ibaraki (JP); Akio Tsujita, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Printing Solutions, Ltd., Tokyo (JP)

(21) Appl. No.: 10/919,269

(22) Filed: Aug. 17, 2004

(30) Foreign Application Priority Data
Sep. 5, 2003 (JP) P2003-314021

(51) Int. Cl. G03G 15/02

(52) U.S. Cl. 399/170; 399/171; 399/172; 399/173

(57) ABSTRACT

In a scorotron type charging device including a shield case having an opening portion toward a photosensitive body, sawtooth electrodes for generating a corona discharge, and a grid having plural grid wires provided at a predetermined interval from sawtooth electrodes, at least one side surface of shield case is arranged adjacent to one sawtooth electrode, and a relationship between a current It supplied to sawtooth electrodes and current Is flowing through shield case is set to satisfy a conditional expression of ¼≦Is/It≦½, and an interval between vertexes of sawteeth of the sawtooth electrodes is set to 1 mm or more but 3 mm or less and a relationship between a charged potential Vo of the photosensitive body and a voltage Vg applied to grid is set to satisfy a conditional expression of −50 V≦|Vo|−|Vg|≦50 (V).

### BACKGROUND OF THE INVENTION

1. Field of the Invention

The present invention relates to a scorotron type charging device used in an electrophotographic image forming apparatus such as a copying machine, a printer, a facsimile, or the like and, more particularly, a charging device using a sawtooth electrode. The invention also relates to an image forming apparatus including the scorotron type charging device.

2. Description of the Related Art

The apparatus using a dry toner occupies the mainstream of the electrophotographic system and such system gives a relatively inexpensive page cost. Thus, such system is used widely in many image forming apparatuses such as a copying machine, a printer, a facsimile, or the like. For example, in an image forming apparatus 100 shown in FIG. 2 and using a photosensitive body 2 that is rotatable and have the negatively charged characteristic, first the photosensitive body 2 is charged uniformly to the negative polarity by a charging device 1. Then, an electrostatic latent image is formed by irradiating a light onto the photosensitive body 2 by an exposing device 3 based on image information. Then, a toner image is formed on the photosensitive body 2 by supplying a toner to the electrostatic latent image by means of a developing device 4. Then, the toner image formed on the photosensitive body 2 is transferred onto a transfer member 7 such as a paper by a transferring device 5. The toner that is not transferred onto the transfer member 7 by the transferring device 5 and still remains on the photosensitive body 2 is cleaned by a cleaning device 6. Then, the toner image that is transferred onto the transfer member 7 is fixed to the transfer member 7 by a fixing device 8, so that a permanent image is formed on the transfer member 7.

An example of the image forming apparatus that is able to form a color image will be explained with reference to FIG. 3 hereunder. As shown in FIG. 3, four printing units each having the photosensitive body 2, the charging device 1, the exposing device 3, the developing device 4, the transferring device 5, and the cleaning device 6 are aligned such that the developing devices 4, into which a different color toner is filled respectively, are assigned to the printing units respectively and four color toners (y, m, c, k) are applied to the transfer member 7 directly or via an intermediate transfer member to form the image on the transfer member 7.

The charging device 1 used in the image forming apparatus in the prior art is of a scorotron type that uses wires as electrode. An example is shown in FIG. 4. A wire electrode 15 is a tungsten wire on a surface of which a gold plating of several μm thickness is applied and which has a diameter of 50 to 100 μm. The corona discharge is generated by applying a high voltage of about −5 kV to the wire electrodes, and the photosensitive body 2 is charged with generated ions. However, such a problem existed that a huge amount of ozone is generated by the wire electrodes 15 to cause degradation of the electric characteristic of the photosensitive body 2 and exert a vicious influence upon a living matter. In addition, such another problem existed that, since a tandem system having the printing unit every toner is effective to get a high printing speed in the color image forming apparatus, an amount of generated ozone is increased rather than a monochromatic image forming apparatus and thus a function of the ozone exhausting mechanism must be enhanced to increase a cost and make a louder noise.

Therefore, recently the charging device 1 using sawtooth electrodes 11, as shown in FIG. 1, which is capable of reducing an amount of generated ozone into about ¼ of the charging device 1 using the wire electrodes 15 was proposed and put to practical use (for example, see JP-A-63-15272).

### SUMMARY OF THE INVENTION

The charging device using the sawtooth electrodes has such a problem that a corona discharge is generated ununiformly at respective sawteeth due to variation in top end shapes of respective sawteeth, or the like, and thus charged potential on the photosensitive body is varied to affect an image.

The present invention has been made in view of the above problem, and it is an object of the present invention to provide a charging device using sawtooth electrodes, capable of uniformizing charged potential on the photosensitive body along its axial direction by generating uniformly the corona discharge at respective sawteeth.

The above object can be attained by providing a scorotron type charging device that includes a shield case having an opening portion toward a photosensitive body, sawtooth electrodes for generating a corona discharge, and a grid having a plurality of grid wires provided at a predetermined interval from the sawtooth electrodes, wherein at least one side surface of the shield case is arranged adjacent to one sawtooth electrode, and a relationship between a current It supplied to the sawtooth electrodes and a current Is flowing through the shield case is set to satisfy a conditional expression of ¼≦Is/It≦½ and wherein an interval between vertexes of sawteeth of the sawtooth electrodes is set to 1 mm or more but 3 mm or less and also a relationship between a charged potential Vo of the photosensitive body and a voltage Vg applied to the grid is set to satisfy a conditional expression of −50 V≦|Vo|−|Vg|≦50 (V).

According to the present invention, the corona discharge can be generated uniformly at respective sawteeth of the sawtooth electrodes, and thus a current that flows through the photosensitive body in the axial direction can be uniformized. Therefore, the excellent image without an image defect can be formed.

### BRIEF DESCRIPTION OF THE DRAWINGS

These and other objects and advantages of this invention will become more fully apparent from the following detailed description taken with the accompanying drawings in which:

FIG. 1 is a sectional view of a charging device having a sawtooth electrode.

FIG. 2 is a schematic view of a printing process in a normal electrophotographic image forming apparatus.

FIG. 3 is a schematic view of a tandem color image forming apparatus.

FIG. 4 is a sectional view of a charging device having wire electrodes.

FIG. 5 is a schematic view of the sawtooth electrode.

FIG. 6 is a graph showing variation in currents flowing through a photosensitive body when Is/It is changed.

### DETAILED DESCRIPTION OF THE PREFERRED EMBODIMENTS

Now, a description will be given in more detail of preferred embodiments of the present invention with reference to the accompanying drawings.

### First Embodiment

FIG. 2 schematically shows an electrophotographic image forming apparatus into which the charging device 1 using the sawtooth electrodes 11 of the present invention is incorporated. In each printing unit, the photosensitive body 2 whose surface is made of organic material is rotatable at a rotational speed of 40 cm/s, and the photosensitive body 2 is charged at about −600 V by the charging device 1 of the present invention. Then, the exposing device 3 is the device that forms an electrostatic latent image by eliminating the charge on the surface of the photosensitive body 2 based on image information, and is formed of LED of 1200 dpi. Then, the toner image is formed on the photosensitive body 2 by supplying the toner to the electrostatic latent image by means of the developing device 4. In the present embodiment, a tandem system in which yellow toner (y), magenta (m) toner, cyan (c) toner, and black (k) toner are aligned from the upstream side of the paper transportation direction is employed. But, the advantage of the present invention is not limited to this system. After such development, each toner image is transferred onto the transfer member 7 by the transferring device 5 in each unit. The transferring device 5 includes a shield case having an opening portion, and wire electrodes for generating the corona discharge, and a current of about 0.8 mA is supplied to the wire electrodes. Respective toner images on the transfer member 7 are fixed onto the transfer member 7 by the fixing device 8. The toners remaining on the photosensitive body 2 are cleaned by the brush-like cleaning device 6.

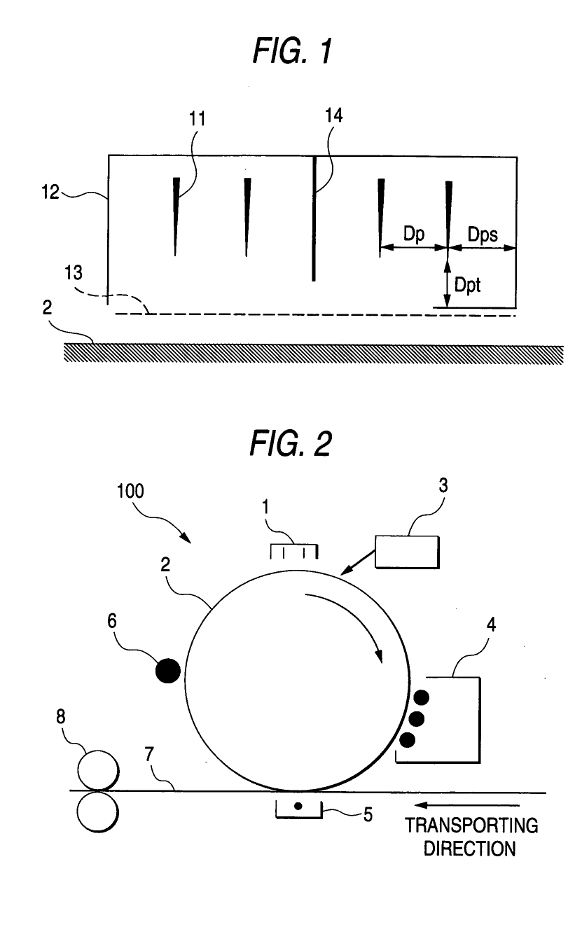

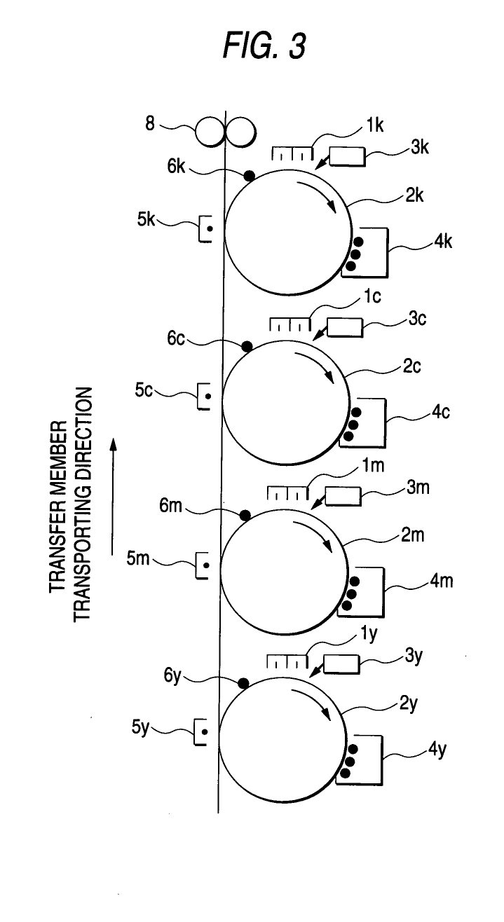

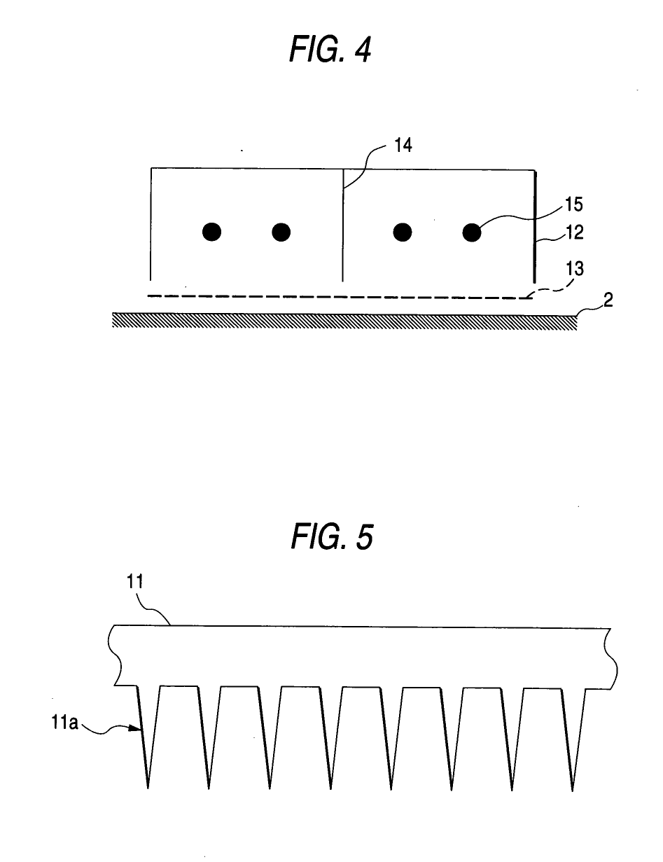

Next, the charging device 1 using the sawtooth electrodes 11 as an embodiment of the present invention shown in FIG. 1, which is used in the image forming apparatus in FIG. 2, will be explained hereunder. Four sawtooth electrodes 11 are employed in the present embodiment, but the advantage of the present invention is not limited to this. The charging device 1 includes a shield case 12 having an opening potion that is opened toward the photosensitive body 2, four sawtooth electrodes 11 for generating the corona discharge, and a grid 13 fitted at a predetermined interval from the sawtooth electrodes 11. The sawtooth electrodes 11 are divided into every two pieces by providing a conductive partition plate 14 in the shield case 12. Since this partition plate 14 is connected electrically to the shield case 12, the current flowing through the partition plate 14 is measure as a current Is that passes through the shield case 12. The sawtooth electrodes 11 are extended in almost parallel with an axial direction of the photosensitive body 2. Respective sawtooth electrodes 11 are arranged in such a way that a distance Dps between the sawtooth electrode 11 and a side surface of the shield case 12 is set to 11 mm, a distance Dp between the sawtooth electrodes 11 is set to 12 mm, and a distance Dpt between a top end portion of the sawtooth electrode 11 and an end portion of the shield case 12 in the vertical direction is set to 6 mm.

The material of the sawtooth electrode 11 is stainless steel (SUS304). A shape of the sawtooth electrode 11 is set such that a thickness is 0.1 mm, a height of a sawtooth 11a is 20 mm, an interval between the sawteeth 11a is 1 mm, an angle of the sawtooth is 15 degree. A shape of the shield case 12 is set to have a width of 70 mm and a length of 600 mm. A shape of the grid 13 is set such that a width of a grid wire is 0.1 mm, a grid interval is 1.3 mm, and a thickness is 0.1 mm. The grid as well as the sawtooth electrode 11 is formed by the etching process. The charging device 1 using the sawtooth electrode is provided in a position that is apart from the photosensitive body 2 by 1.5 mm. The shield case 12 is held at a ground potential. A power supply of the sawtooth electrode 11 is controlled based on a current, and a power supply of the grid 13 is controlled based on a voltage.

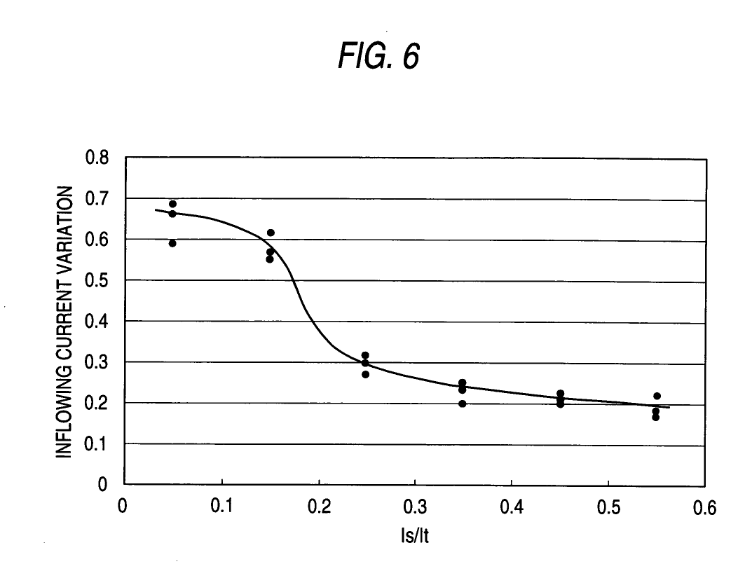

Then, in the charging device 1 using the sawtooth electrode 11, variation of a current flowing through the photosensitive body 2 in its axial direction was measured while adjusting the distance Dpt between the top end portion of the sawtooth electrode 11 and the end portion of the shield case 12 in the vertical direction to change a current Is flowing into the shield case 12, and also the advantage of the present invention was checked based on evaluation of the printed picture quality in the image forming apparatus in FIG. 2. At this time, a current It flowing through the sawtooth electrode is adjusted to make the current flowing through the photosensitive body constant. The result of variation measurement is shown in FIG. 6. As shown in FIG. 6, if the current Is flowing into the shield case 12 is increased, the corona discharge was generated uniformly at respective sawteeth 11a and as a result the current flowing through the photosensitive body 2 in its axial direction was made uniform. Also, if variation in the current flowing through the photosensitive body 2 is suppressed smaller than 0.3 μA/m, i.e, if a relationship of the current Is flowing into the shield case 12 and the current It flowing through the sawtooth electrode 11 of the present invention is set to satisfy a conditional expression of Is/It≧¼ based on the evaluated result of the printed picture quality of the fine line pattern (2ON4OFF) in which image inequality is ready to occur due to variation in the charged potential of the photosensitive body 2, the excellent image could be formed without the image defect that appears as a black stripe when a line width becomes different by almost 20% due to variation in the charged potential. In addition, if the relationship Is/It is increased excessively, the current flowing through the sawtooth electrode 11 must be increased to get a predetermined charged potential. As a result, since an amount of generated ozone is increased to accelerate the degradation of the photosensitive body and bring about reduction in the life time, the relationship must be set to Is/It≦½.

In the above explanation, the distance Dpt between the top end portion of the sawtooth electrode 11 and the end portion of the shield case 12 in the vertical direction is adjusted. In this case, if the relationship of the current Is flowing into the shield case 12 between the current It flowing through the sawtooth electrode 11 of the present invention is set to satisfy the conditional expression of Is/It≧¼, the excellent image without the image defect could also be formed by adjusting the distance Dps between the sawtooth electrode 11 and the side surface of the shield case 12.

### Second Embodiment

Further, the advantage of the present invention was checked by performing the printing experiment similar to the embodiment 1 while using the sawtooth electrode 11 in which an interval between vertexes of the sawteeth 11a is changed by 1 mm at a time from 1 mm to 5 mm. At this time, the sawtooth electrodes 11 were arranged such that the relationship between the current Is flowing into the shield case 12 and the current It supplied to the sawtooth electrode 11 satisfies Is/It=¼, and a relationship between a charged potential Vo of the photosensitive body 2 and a voltage Vg applied to the grid 13 was set to |Vo|−|Vg|=0 V. As a result, if an interval between vertexes of the sawteeth 11a is set to 4 mm or more, the image defect that appears as the black stripe when the line width becomes different by almost 20% due to variation in the charged potential still appeared and thus the excellent image could not be formed. In contrast, if an interval between vertexes of the sawteeth 11a is set to 3 mm or less, the excellent image without the image defect could be formed. Also, if the interval between the sawteeth 11a is set excessively narrow, the electric fields of adjacent sawteeth 11a interfere with each other and the corona discharge is hard to occur. With the above, the interval between vertexes of the sawteeth 11a must be set to 1 mm or more but 3 mm or less.

Moreover, the advantage of the present invention was checked by performing the printing experiment similar to the embodiment 1 while changing the relationship between a charged potential Vo of the photosensitive body 2 and a voltage Vg applied to the grid 13 by using the sawtooth electrode 11 in which the interval between vertexes of the sawteeth 11a is changed from 1 mm to 3 mm. As a result, if the relationship between the charged potential Vo of the photosensitive body 2 and the voltage Vg applied to the grid 13 is given to satisfy the conditional expression of |Vo|−|Vg|≧−50 V, the excellent image without the image defect could be formed. In contrast, if |Vo|−|Vg| becomes too large, an amount of generated ozone is increased to accelerate the degradation of the photosensitive body and bring about reduction in the life time. Therefore, the above relationship must be set to |Vo|−|Vg|≦50 V.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A scorotron type charging device comprising:
a shield case having an opening portion toward a photosensitive body;
sawtooth electrodes for generating a corona discharge; and
a grid having a plurality of grid wires provided at a predetermined interval from the sawtooth electrodes,
wherein at least one side surface of the shield case is arranged adjacent to one sawtooth electrode, and a relationship between a current It supplied to the sawtooth electrodes and a current Is flowing through the shield case is set to satisfy a conditional expression of ¼≦Is/It≦½.

2. The charging device according to claim 1, wherein an interval between vertexes of sawteeth of the sawtooth electrodes is set to 1 mm or more but 3 mm or less, and also a relationship between a charged potential Vo of the photosensitive body and a voltage Vg applied to the grid is set to satisfy a conditional expression of −50 V≦|Vo|−|Vg|≦50 (V).

3. An image forming apparatus including a scorotron type charging device, the scorotron type charging device comprising:
a shield case having an opening portion toward a photosensitive body;
sawtooth electrodes for generating a corona discharge; and
a grid having a plurality of grid wires provided at a predetermined interval from the sawtooth electrodes,
wherein at least one side surface of the shield case is arranged adjacent to one sawtooth electrode, and a relationship between a current It supplied to the sawtooth electrodes and a current Is flowing through the shield case is set to satisfy a conditional expression of ¼≦Is/It≦½.

4. The apparatus according to claim 3, wherein an interval between vertexes of sawteeth of the sawtooth electrodes is set to 1 mm or more but 3 mm or less, and also a relationship between a charged potential Vo of the photosensitive body and a voltage Vg applied to the grid is set to satisfy a conditional expression of −50 V≦|Vo|−|Vg|≦50 (V).
